(19) United States
(12) Patent Application Publication
(10) Pub. No.: US 2026/0253074 A1
(43) Pub. Date: Aug. 27, 2026

(54) SYSTEMS AND METHODS FOR SECURE TRANSACTION VALIDATION UTILIZING TRUSTED LOCATIONS AND CONTEXTUAL AUTHENTICATION

(71) Applicant: Wells Fargo Bank, N.A., San Francisco, CA (US)

(72) Inventors: Matthew N. Wheeler, Charlotte, NC (US); Daniel Sanford, Charlotte, NC (US); John Andrew Chuprevich, Davidson, NC (US)

(21) Appl. No.: 19/064,053

(22) Filed: Feb. 26, 2025

(51) Int. Cl. G06Q 20/40

(52) U.S. Cl. CPC G06Q 20/401

(57) ABSTRACT

Systems, apparatuses, methods, and computer program products are disclosed for providing secure transaction validation. An example method includes receiving a transaction request from a user device, wherein the transaction request is associated with a user account and the transaction request comprises location data of the user device. The example method further includes determining that a restriction applies to the transaction request for the user account and determining whether the location data corresponds to a trusted location associated with a verified trusted organization using a verified trusted organization repository. The example method further includes modifying the restriction applied to the transaction request in response to determining that the location data corresponds to the trusted location. The example method further includes evaluating whether the transaction request is permissible based on the modified restriction and in response to determining that the transaction request is permissible, validating the transaction request for the user account.

### BACKGROUND

Digital payments, mobile banking, and contactless transactions have become increasingly prevalent. While existing security measures, such as passwords, personal identification numbers (PINs), and multifactor authentication (MFA), provide a baseline level of protection, they introduce user friction and remain susceptible to various threats, such as credential theft, phishing attacks, and location spoofing.

### BRIEF SUMMARY

The growing reliance on digital payment systems has heightened the demand for enhanced transaction security. Conventional authentication methods, such as passwords, PINs, and MFA, offer limited protection for user accounts, but they remain vulnerable to credential theft, phishing, and location spoofing. To combat fraud, some institutions have adopted risk-based authentication, which considers factors such as user behavior, transaction patterns, and user device attributes. While these methods improve security, they rely on statistical risk scoring, which often leads to false positives that block legitimate transactions or false negatives that allow fraudulent transactions to proceed.

A significant challenge in securing digital transactions is ensuring that the transaction request originates from a legitimate user in a trusted location. Traditional fraud detection systems may flag transactions as suspicious if they originate from an unfamiliar location or unfamiliar device, and the user may be required to complete additional verification steps. This may degrade the overall user experience. Moreover, bad actors may bypass detection using various techniques, such as location spoofing, SIM swapping, and/or session hijacking, ultimately leading to fraudulent transactions despite these security protocols.

Furthermore, conventional transaction systems impose rigid, predefined transaction limits that do not adapt to contextual security conditions. These conventional systems enforce static thresholds for transaction amounts, regardless of whether a transaction is occurring in a high-trust environment. This forces users to seek out manual intervention, such as from customer service support, to modify limits. This approach is inefficient and burdensome for all parties.

In contrast to these conventional techniques for transaction verification, example embodiments described herein may leverage user device location data to assess the legitimacy of a transaction request. Example embodiments thus provide for an adaptive security framework that integrates trusted location and contextual authentication to enable secure and efficient transaction processing without unnecessary disruptions. Example embodiments allow for modification of a restriction that applies to a transaction request if location data received from a user device corresponds to (e.g., matches or is located within) a trusted location. Example embodiments may then evaluate whether a transaction request is permissible based on the modified restriction.

In some embodiments, device signals received from a user device and/or an organization device associated with a trusted location can be used to further modify a restriction. For example, a received device signal may confirm that the user device is within a threshold proximity of an organization device at a trusted location. Because the organization device is known to be securely linked to the trusted location, this proximity serves as additional proof that the user is physically present at the trusted location. Advantageously, the use of device signals enhances security by mitigating location spoofing risks.

In some embodiments, example embodiments apply a tiered restriction modification framework when processing a transaction request. A first-tier restriction modification rule set may define how a restriction can be modified if the user device location corresponds to a trusted location but lacks supporting device signals. A second-tier restriction modification rule set may define how a restriction can be modified when both location data and device signals confirm the user's presence at the trusted location. The second-tier restriction modification rule set may allow the restrictions to be relaxed more than the first-tier restriction modification rule set. Thus, this tiered approach enhances security in a flexible manner that is further considerate of the contextual environment where the transaction request is occurring.

In some embodiments, a verified trusted organization repository may be configured to store records of verified trusted organizations that have been successfully verified and registered. Each record may include one or more trusted locations that correspond to physical locations associated with the verified trusted organization. An organization must undergo a registration process to be vetted as a verified trusted organization and included in the verified trusted organization repository. By defining a trusted location and requiring organizations to register and be vetted, example embodiments ensure that transactions originating or associated with these locations are more likely to be legitimate, thereby reducing the risk of fraudulent activity. In some embodiments, the verified trusted organization repository may act as a centralized repository that can be queried in real-time while processing a transaction request, thus enabling quick and efficient fraud detection.

Accordingly, the present disclosure sets forth systems, methods, and apparatuses to provide for secure and efficient transaction validation. By incorporating location data, device signals, and organization verification, example embodiments introduce a layer of contextual security and, in doing so, reduce reliance on traditional risk-based authentication models. Thus, this approach further minimizes false positives and negatives, thereby improving transaction request processing accuracy while enhancing fraud prevention and reducing user friction. Furthermore, example embodiments protect against location spoofing and global positioning system (GPS) manipulation by cross-validating location data with device signals to verify the physical presence of the user at the trusted location.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for secure location-based transaction processing.

FIG. 2 illustrates a schematic block diagram of example circuitry embodying a system device that may perform various operations, in accordance with some example embodiments described herein.

FIG. 3 illustrates a schematic block diagram of example circuitry embodying a user device or organization device that may perform various operations, in accordance with some example embodiments described herein.

FIG. 4 illustrates an example flowchart for adding an organization to a verified trusted organization repository, in accordance with some example embodiments described herein.

FIG. 5 illustrates an example flowchart for processing a transaction request based on location data, in accordance with some example embodiments described herein.

FIG. 6 illustrates an example flowchart for evaluating received device signals, in accordance with some example embodiments described herein.

FIG. 7 illustrates an example flowchart for processing a transaction request that is associated with a product token, in accordance with some example embodiments described herein.

FIG. 8 illustrates an example flowchart for providing a transaction generation request as performed by an organization device, in accordance with some example embodiments described herein.

FIG. 9 illustrates an example flowchart for providing a transaction request as performed by a user device, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers, programmable automation controllers, industrial computers, desktop computers, personal data assistants, laptop computers, tablet computers, smartbooks, palm-top computers, personal computers, smartphones, wearable devices (such as headsets, smartwatches, or the like), and similar electronic devices equipped with at least a processor and any other physical components necessary to perform the various operations described herein. Devices such as smartphones, laptop computers, tablet computers, and wearable devices are generally collectively referred to as “mobile devices.”

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

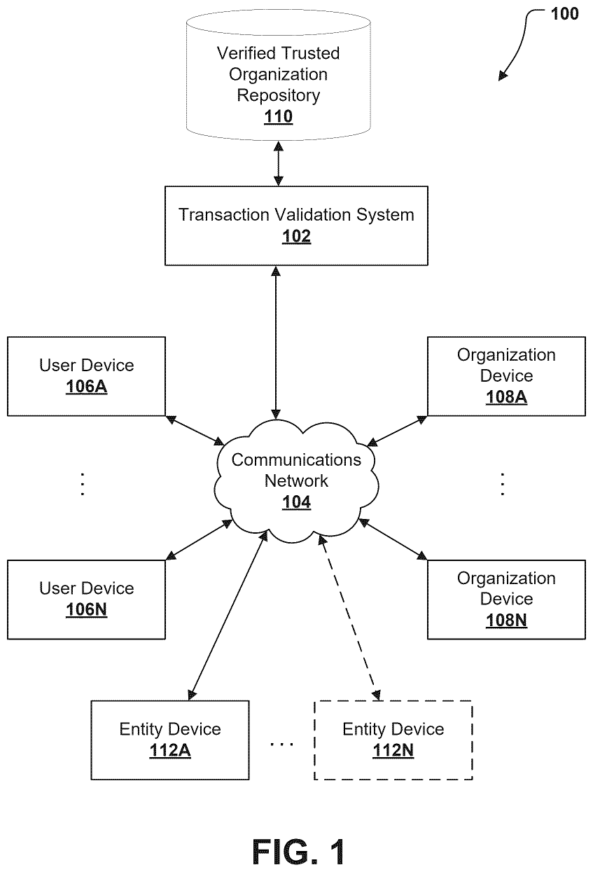

Example embodiments described herein may be implemented using any of a variety of computing devices or servers. To this end, FIG. 1 illustrates an example environment 100 within which various embodiments may operate. As illustrated, a transaction validation system 102 may receive and/or transmit information via communications network 104 (e.g., the Internet) with any number of other devices, such as one or more of user devices 106A-106N, organization devices 108A-108N, and/or entity devices 112A-112N.

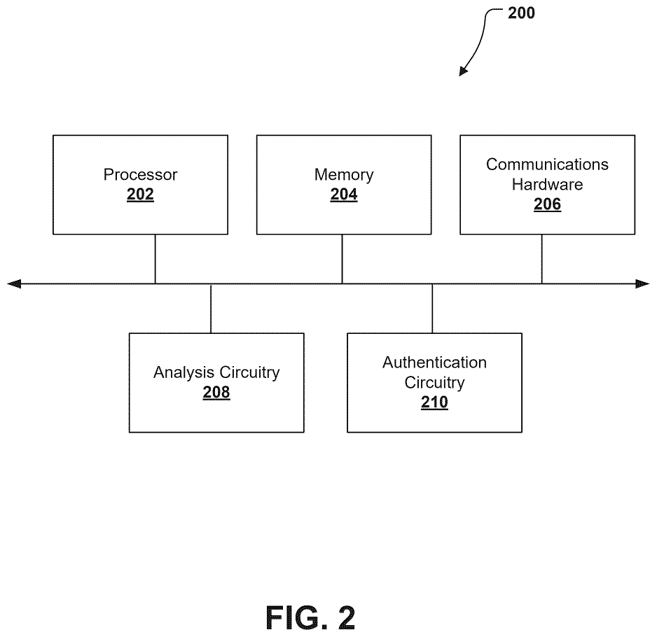

The transaction validation system 102 may be implemented as one or more computing devices or servers, which may be composed of a series of components. Particular components of the transaction validation system 102 are described in greater detail below with reference to the apparatus 200 in connection with FIG. 2.

In some embodiments, the transaction validation system 102 further includes a verified trusted organization repository 110 that comprises a distinct component from other components of the transaction validation system 102. The verified trusted organization repository 110 may be embodied as one or more direct-attached storage devices (such as hard drives, solid-state drives, optical disc drives, or the like) or may alternatively comprise one or more network-attached storage devices independently connected to a communications network (e.g., communications network 104). The verified trusted organization repository 110 may host the software executed to operate the transaction validation system 102. The verified trusted organization repository 110 may store information relied upon during operation of the transaction validation system 102, such as various records for verified trusted organizations, data and documents to be analyzed using the transaction validation system 102, or the like.

The one or more user devices 106A-106N, the one or more organization devices 108A-108N, and the one or more entity devices 112A-112N may be embodied by any computing devices known in the art. The one or more user devices 106A-106N, the one or more organization devices 108A-108N, and the one or more entity devices 112A-112N need not themselves be independent devices but may be peripheral devices communicatively coupled to other computing devices. In some embodiments, a user device (e.g., any one of user devices 106A-106N) may be associated with a user who is associated with a user account maintained by the transaction validation system 102 (e.g., a customer). In some embodiments, an organization device (e.g., any one of organization devices 108A-108N) may be associated with a verified trusted organization. In some embodiments, an entity device (e.g., any one of entity devices 112A-112N) may affiliated with the transaction validation system 102. In some embodiments, an entity device (e.g., any one of entity devices 112A-112N) may be associated with an authorized user (e.g., an employee of an institution that operates or is associated with the transaction validation system 102).

Although FIG. 1 illustrates an environment and implementation in which the transaction validation system 102 interacts indirectly with a user via one or more of user devices 106A-106N, organization devices 108A-108N, and entity devices 112A-112N, in some embodiments, users may directly interact with the transaction validation system 102 (e.g., via communications hardware of the transaction validation system 102), in which case separate user devices 106A-106N, organization devices 108A-108N, and/or entity devices 112A-112N may not be utilized. Whether by way of direct interaction or indirect interaction via another device, a user may communicate with, operate, control, modify, or otherwise interact with the transaction validation system 102 to perform the various functions and achieve the various benefits described herein.

### Example Implementing Apparatuses

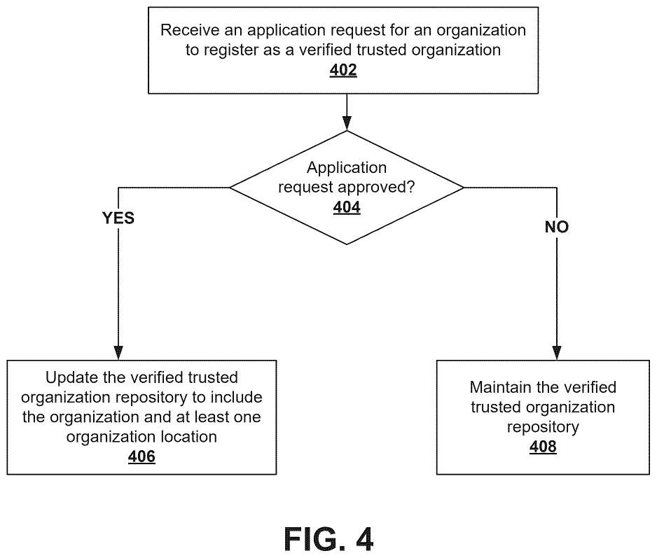

The transaction validation system 102 (described previously with reference to FIG. 1) may be embodied by one or more computing devices or servers, shown as the apparatus 200 in FIG. 2. The apparatus 200 may be configured to execute various operations described above in connection with FIG. 1 and below in connection with FIGS. 4-7. As illustrated in FIG. 2, the apparatus 200 may include a processor 202, a memory 204, a communications hardware 206, an analysis circuitry 208, and an authentication circuitry 210, each of which will be described in greater detail below.

The processor 202 (and/or co-processor or any other processor assisting or otherwise associated with the processor) may be in communication with the memory 204 via a bus for passing information among components of the apparatus 200. The processor 202 may be embodied in a number of different ways and may, for example, include one or more processing devices configured to perform independently. Furthermore, the processor 202 may include one or more processors configured in tandem via a bus to enable independent execution of software instructions, pipelining, and/or multithreading. The use of the term “processor” may be understood to include a single-core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor 202 may be configured to execute hard-coded functionality. As such, whether configured by hardware or software methods, or by a combination of hardware with software, the processor 202 represents an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, software instructions, or the like for enabling the apparatus 200 to carry out various functions in accordance with example embodiments contemplated herein.

The communications hardware 206 may be any means, such as a device or circuitry embodied in either hardware or a combination of hardware and software, that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of a user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., the memory 204) accessible to the processor 202.

In addition, the apparatus 200 further comprises the analysis circuitry 208, which may be configured to determine whether a restriction applies to a transaction request, determine whether location data corresponds to a trusted location, determine whether to modify a restriction, evaluate whether a transaction request is permissible, validate a transaction request, and effectuate a transaction for a transaction request. In some embodiments, the analysis circuitry 208 may further be configured to deny a transaction request and select a trusted location. In some embodiments, the analysis circuitry 208 may further be configured to evaluate device signals. In some embodiments, the analysis circuitry 208 may further be configured to update a verified trusted organization repository. The analysis circuitry 208 may utilize the processor 202, the memory 204, or any other hardware component included in the apparatus 200 to perform these operations, as described in connection with FIGS. 4-7 below. The analysis circuitry 208 may further utilize the communications hardware 206 to gather data from a variety of sources (e.g., any one of user devices 106A-106N, organization devices 108A-108N, and/or entity devices 112A-112N, as shown in FIG. 1) and/or exchange data with a user.

In addition, the apparatus 200 further comprises the authentication circuitry 210, which may be configured to evaluate whether a candidate product token corresponds to a stored product token, generate a product token, store a product token, generate an initial transaction request, extract a candidate product identifier from a transaction request, generate a candidate product token, and/or the like. The authentication circuitry 210 may utilize the processor 202, the memory 204, or any other hardware component included in the apparatus 200 to perform these operations, as described in connection with FIGS. 4-7 below. The authentication circuitry 210 may further utilize the communications hardware 206 to gather data from a variety of sources (e.g., any one of user devices 106A-106N, organization devices 108A-108N, and/or entity devices 112A-112N, as shown in FIG. 1) and/or exchange data with a user.

Although components 202-210 are described in part using functional language, it will be understood that the particular implementations necessarily include the use of particular hardware. It should also be understood that certain of these components 202-210 may include similar or common hardware. For example, the analysis circuitry 208 and the authentication circuitry 210 may each at times leverage use of the processor 202, the memory 204, or the communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus 200 therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the analysis circuitry 208 and the authentication circuitry 210 may leverage the processor 202, the memory 204, or the communications hardware 206, as described above, it will be understood that any of the analysis circuitry 208 and the authentication circuitry 210 may include one or more dedicated processors, specially configured field-programmable gate array, or application-specific interface circuit to perform its corresponding functions and may accordingly leverage the processor 202 executing software stored in a memory (e.g., the memory 204) or the communications hardware 206 for enabling any functions not performed by special-purpose hardware. In all embodiments, however, it will be understood that the analysis circuitry 208 and the authentication circuitry 210 comprise particular machinery designed for performing the functions described herein in connection with such elements of the apparatus 200.

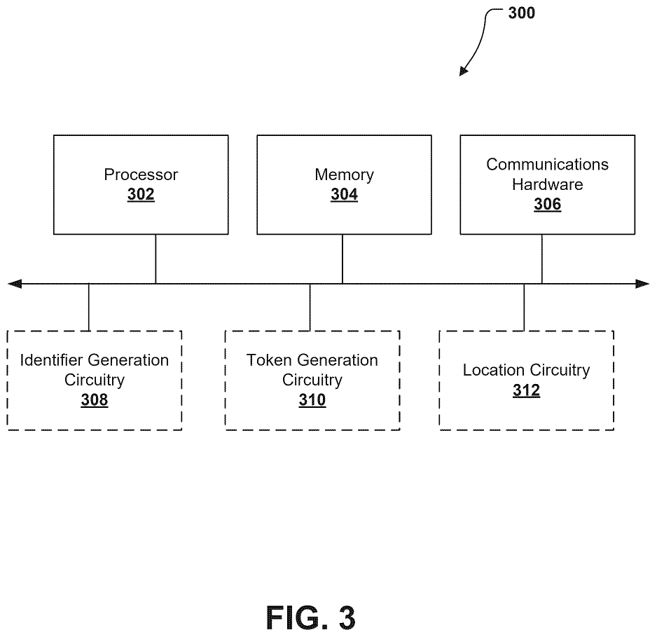

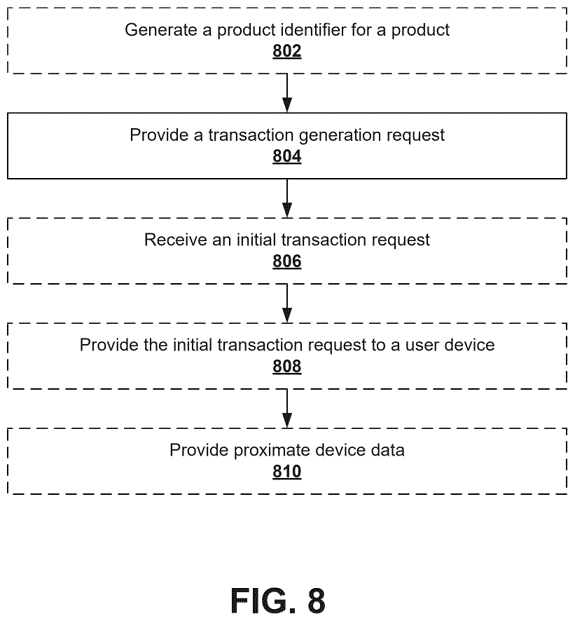

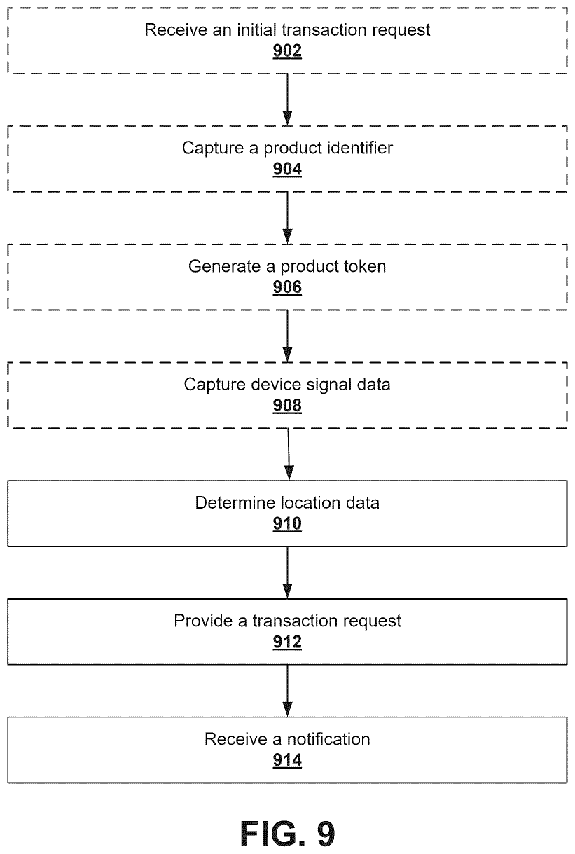

As illustrated in FIG. 3, an apparatus 300 is shown that represents an example user device (e.g., any one of user devices 106A-106N) or an example organization device (e.g., any of organization devices 108A-108N). The apparatus 300 may be configured to execute various operations described above in connection with FIG. 1 and below in connection with FIGS. 8-9. The apparatus 300 includes a processor 302, a memory 304, and a communications hardware 306, each of which is configured to be similar to the similarly named components described above in connection with FIG. 2. The apparatus 300 may optionally include an identifier generation circuitry 308, a token generation circuitry 310, and a location circuitry 312.

In some embodiments, the apparatus 300 comprises an identifier generation circuitry 308, which may be configured to generate a product identifier for a product, generate a visual representation of the product identifier, and/or the like. The identifier generation circuitry 308 may utilize the processor 302, the memory 304, or any other hardware component included in the apparatus 300 to perform these operations, as described in connection with FIGS. 8-9 below. The identifier generation circuitry 308 may further utilize the communications hardware 306 to gather data from a variety of sources (e.g., any one of user devices 106A-106N, organization devices 108A-108N, entity devices 112A-112N, and/or transaction validation system 102, as shown in FIG. 1) and/or exchange data with a user.

In some embodiments, the apparatus 300 comprises a token generation circuitry 310, which may be configured to generate a product token. The token generation circuitry 310 may utilize the processor 302, the memory 304, or any other hardware component included in the apparatus 300 to perform these operations, as described in connection with FIGS. 8-9 below. The token generation circuitry 310 may further utilize the communications hardware 306 to gather data from a variety of sources (e.g., any one of user devices 106A-106N, organization devices 108A-108N, entity devices 112A-112N, and/or transaction validation system 102, as shown in FIG. 1) and/or exchange data with a user.

In some embodiments, the apparatus 300 comprises a location circuitry 312, which may be configured to determine location data. The location circuitry 312 may utilize the processor 302, the memory 304, or any other hardware component included in the apparatus 300 to perform these operations, as described in connection with FIGS. 8-9 below. The location circuitry 312 may further utilize the communications hardware 306 to gather data from a variety of sources (e.g., any one of user devices 106A-106N, organization devices 108A-108N, entity devices 112A-112N, and/or transaction validation system 102, as shown in FIG. 1) and/or exchange data with a user.

In some embodiments, various components of the apparatuses 200 and 300 may be hosted remotely (e.g., by one or more cloud servers) and thus need not physically reside on the corresponding apparatus 200 or 300. For instance, some components of the apparatus 200 may not be physically proximate to the other components of apparatus 200. Similarly, some or all of the functionality described herein may be provided by third-party circuitry. For example, a given apparatus 200 may access one or more third-party circuitries in place of local circuitries for performing certain functions.

As will be appreciated based on this disclosure, example embodiments contemplated herein may be implemented by an apparatus 200 or 300. Furthermore, some example embodiments may take the form of a computer program product comprising software instructions stored on at least one non-transitory computer-readable storage medium (e.g., the memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by the apparatus 200 as described in FIG. 2 or apparatus 300 as described in FIG. 3, that loading the software instructions onto a computing device or apparatus produces a special-purpose machine comprising the means for implementing various functions described herein.

Having described specific components of example apparatus 200, example embodiments are described below in connection with a series of graphical user interfaces and flowcharts.

### Example Operations Performed by the Transaction Validation System

Turning to FIGS. 4-7, example flowcharts are illustrated that contain example operations implemented by example embodiments described herein. The operations illustrated in FIGS. 4-7 may, for example, be performed by the transaction validation system 102 shown in FIG. 1, which may in turn be embodied by an apparatus 200, which is shown and described in connection with FIG. 2. To perform the operations described below, the apparatus 200 may utilize one or more of the processor 202, the memory 204, the communications hardware 206, the analysis circuitry 208, the authentication circuitry 210, and/or any combination thereof. It will be understood that user interaction with the transaction validation system 102 may occur directly via the communications hardware 206 or may instead be facilitated by a separate user device (e.g., any one of user devices 106A-106N), a separate entity device (e.g., any one of entity devices 112A-112N), and/or separate organization device (e.g., any one of organization devices 108A-108N), as shown in FIG. 1, and may have similar or equivalent physical componentry facilitating such user interaction.

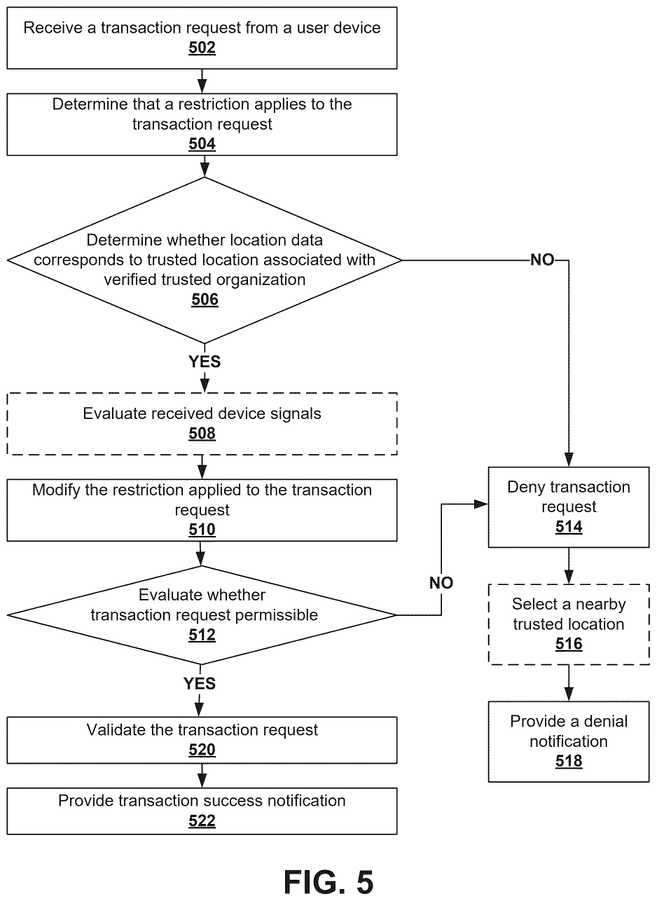

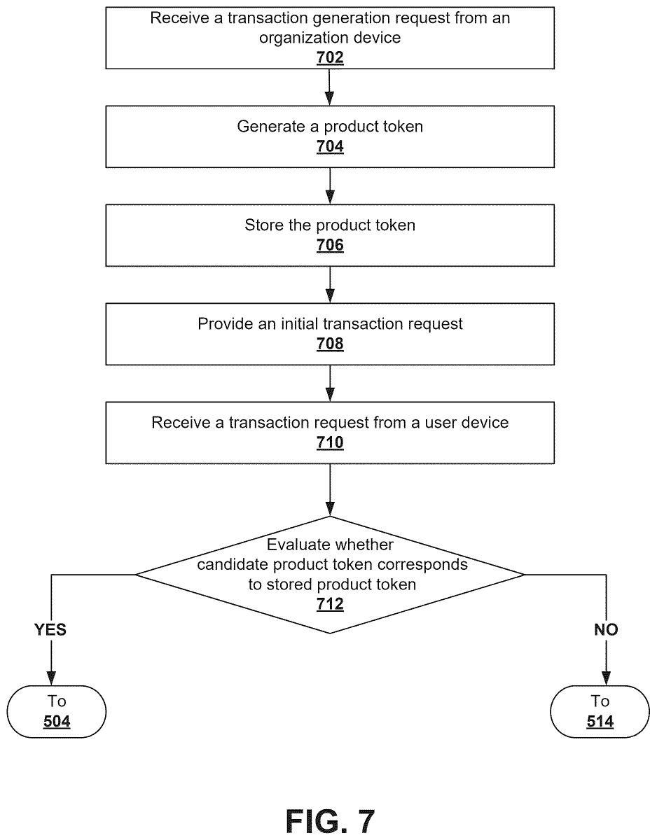

Turning first to FIG. 4, example operations are shown for adding an organization to a verified trusted organization repository. As shown by operation 402, the apparatus 200 includes means, such as the communications hardware 206 or the like, for receiving an application request for an organization to register as a verified trusted organization. The communications hardware 206 may receive an application request from an organization device (e.g., any one of organization devices 108A-108N) to register an associated organization as a verified trusted organization. An application request may be received when an organization wishes to register as a verified trusted organization. As discussed in greater detail in FIGS. 5 and 7, transactions that occur at a trusted location associated with a verified trusted organization may receive benefits, such as increased transaction limits, decreased transaction processing times, bypassed certain authentication protocols, enabling previously restricted payment methods, removing temporary freezes and/or holds, and/or the like.

An application request may include identifying information for the organization. For example, the application request may include an organization name, business type, one or more organization locations, and/or the like. In some embodiments, the application request may further include verification data, such as registration documents, digital signatures, authentication tokens, associated entity accounts (e.g., financial accounts), and/or the like. Thus, the application request may include details that allow the apparatus 200 or an authorized user to validate the organization's legitimacy.

In some embodiments, the application request may further include one or more organization device identifiers for an organization device associated with an organization location. The one or more organization device identifiers may include a media access control (MAC) address, an international mobile equipment identity (IMEI), an internet protocol (IP) address, a Bluetooth address, and/or the like. In some embodiments, the communications hardware 206 may receive this information in a separate communication other than the application request.

In some embodiments, the application request may further include an indication of one or more acceptable payment rails for the organization. For example, the one or more acceptable payment rails may include automated clearing house (ACH) payments, wire transfers, electronic checks, peer-to-peer (P2P) payment services (e.g., Zelle®), and/or the like. The application request may further indicate payment details for the organization. For example, the application request may indicate routing numbers, account numbers, and/or other identifiers for each payment rail. In some embodiments, the communications hardware 206 may receive this information in a separate communication other than the application request.

As shown by operation 404, the apparatus 200 includes means, such as the communications hardware 206, the analysis circuitry 208, or the like, for receiving either an approval of the application request or a denial of the application request. In some embodiments, the application request may be reviewed by an authorized user (e.g., an employee, manager, reviewer, or other authorized personnel) associated with the apparatus 200. In some embodiments, the authorized user may manually review the application request. In turn, the communications hardware 206 may receive an approval or denial of the application request from an entity device (e.g., any one of entity devices 112A-112N).

Additionally, or alternatively, in some embodiments, the analysis circuitry 208 may be configured to automatically review the application request and may either provide a recommendation to the authorized user or automatically approve the application request. In some embodiments, the analysis circuitry 208 may perform verification procedures to verify at least a portion of the information within the application request. For example, in some embodiments, the analysis circuitry 208 may be configured to use the communications hardware 206 to cross-reference information included in the application request with one or more external databases, validate any business licenses, and/or confirm operational statuses of the organization. If the analysis circuitry 208 is able to successfully verify at least a portion of the information included in the application request (e.g., at least an organization name, business type, and one or more organization locations), the analysis circuitry 208 may either use the communications hardware 206 to provide a recommendation to the entity device and/or automatically approve the application request. If the application request is approved, the process may proceed to operation 406. Otherwise, the process may proceed to operation 408.

As shown by operation 406, the apparatus 200 includes means, such as the communications hardware 206, the analysis circuitry 208, or the like, for updating the verified trusted organization repository to include the organization and the at least one organization location. If the application request was approved, the analysis circuitry 208 may update the verified trusted organization repository 110 to include the organization. In some embodiments, the analysis circuitry 208 may use the communications hardware 206 to update the verified trusted organization repository 110 to include a new record for the organization. Thus, the verified trusted organization repository 110 may be updated with a new record that reflects the organization as a verified trusted organization.

A verified trusted organization repository 110 may be a secure database or data structure configured to store information pertaining to organizations that have been successfully verified and registered as trusted organizations. In some embodiments, the verified trusted organization repository 110 may store records of each verified trusted organization. Each record may include organization identification information, such as the organization name, business type, and/or other unique identifiers (e.g., registration number, digital certificate, authentication token). Each record may further include one or more trusted locations, which are physical locations associated with the organization. In some embodiments, a record may further be associated with verification details, such as an application request approval date, a verification authority (e.g., the particular authorized user who approved the application request and/or whether the application was approved by the apparatus 200), expiration statuses, renewal requirements, and/or the like.

In some embodiments, a record for a verified trusted organization may further include one or more organization device identifiers for an organization device associated with a particular trusted location. For example, the one or more organization device identifiers may correspond to a MAC address, an IMEI, an IP address, a Bluetooth address, and/or the like.

In some embodiments, the record for a verified trusted organization may further include one or more acceptable payment rails. For example, the one or more acceptable payment rails may include ACH payments, wire transfers, electronic checks, P2P payment services (e.g., Zelle®), and/or the like. In some embodiments, the record may further indicate payment details for the verified trusted organization. For example, the record may further indicate routing numbers, account numbers, and/or other identifiers for each payment rail.

Alternatively, as shown by operation 408, the apparatus 200 includes means, such as the analysis circuitry 208 or the like, for maintaining the verified trusted organization repository. If the application request is not approved, the analysis circuitry 208 may maintain the verified trusted organization repository 110. If an application request for an organization is denied or otherwise not approved, this may indicate that one or more details of the organization could not be verified. Thus, the application request may be denied until the details of the application request can be verified for the requesting organization. In this way, the integrity of the verified trusted organization repository 110 is maintained. As discussed below in FIGS. 5 and 7, this ensures that restrictions on transaction requests are not modified for transaction requests occurring at a non-verified location.

Turning next to FIG. 5, example operations are shown for processing a transaction request based on location data. As shown by operation 502, the apparatus 200 includes means, such as the communications hardware 206 or the like, for receiving a transaction request from a user device. The communications hardware 206 may receive a transaction request from a user device (e.g., any one of user devices 106A-106N). For example, the communications hardware 206 may receive the transaction request from the user device 106A. A transaction request may be an electronic request to initiate an operation related to a user account of the user. In some embodiments, a transaction request may refer to a user's request to perform a transaction type. For example, a transaction type may be to purchase a good or service, transfer funds, withdraw cash, authorize an operation for a user account, and/or the like. The transaction request may further include transaction data, such as a transaction amount, a recipient account, a recipient device, a transaction date, a selected payment rail, and/or the like.

In some embodiments, the transaction request may include user account information. For example, the transaction request may include a user account number, username associated with the user account, email address associated with the user account, and/or authentication token associated with the user account. In some embodiments, the user may provide a login request using an associated mobile application via the user device 106A. The communications hardware 206 may receive the login request, which may include candidate user credentials (e.g., biometric data, a password, a passcode, a digital signature, and/or the like). If successfully authenticated, the communications hardware 206 may provide the user device 106A a session token (e.g., an authentication token) to use for a limited time. Thus, the user may access the user account and initiate a transaction request from within the mobile application, and the transaction request may include the session token (e.g., authentication token).

In some embodiments, the transaction request may include location data. The location data may pertain to the location of the user device 106A. This location data for the user device 106A may be used as a proxy for the location of the user. The location data may include GPS coordinates, cell tower signals and/or signal strength, a Wi-Fi network service set identifier, and/or the like.

In some embodiments, the transaction request may further include device signals of devices proximate to the user device 106A. For example, device signals may include Bluetooth signals, near-field communication (NFC) signals, radio-frequency identification (RFID) signals, ultra-wideband (UWB) signals, and/or the like. Each device signal may include a device identifier that is indicative of the device providing the signal. For example, a Bluetooth signal may include a device MAC address and/or device name. As another example, an NFC signal may include a unique NFC tag identifier. As another example, a RFID signal may include a unique tag identifier. As another example, a UWB signal may include a device identifier, such as a MAC address and/or randomized identifier. In some embodiments, the device signals may further include a power level and/or signal strength associated with a detected device signal.

As shown by operation 504, the apparatus 200 includes means, such as the analysis circuitry 208 or the like, for determining that a restriction applies to the transaction request. Upon receiving the transaction request, the communications hardware 206 may provide the transaction request to analysis circuitry 208 for further analysis. The analysis circuitry 208 may evaluate the transaction request to determine whether it is subject to a restriction. A restriction may refer to a limitation, condition, or control applied to a user account. The restriction may affect whether the transaction request can be effectuated or otherwise completed. A restriction may be temporary or permanent, and further, it may be specific to the particular user account or may apply to other user accounts. For example, a restriction may be a user-defined limit, such as a daily spending cap, withdrawal limit, etc. As another example, a restriction may be a system-imposed restriction, such as maximum transaction limits per transaction, total daily transaction limits or other time frame, a suspicious activity lock on the user account, limits on transactions originating from or directed to certain geographic locations, limits based on a user account age, limits based on an associated user device trust score, and/or the like.

The analysis circuitry 208 may evaluate the transaction request and/or user account to determine whether any restrictions apply. For example, the analysis circuitry 208 may evaluate the transaction request to determine whether a transaction amount exceeds a maximum transaction limit per transaction or user-defined limits. As another example, the analysis circuitry 208 may further evaluate other transactions from the user account to determine whether the transaction amount would exceed a transaction limit for a defined time period (e.g., one day) and/or user-defined limits. As another example, the analysis circuitry 208 may further evaluate whether the user account is subject to an activity lock.

In some embodiments, the analysis circuitry 208 may determine that one or more restrictions apply to the transaction request, and thus, the transaction request cannot be completed without further analysis. In some embodiments, the analysis circuitry 208 may evaluate whether the transaction request includes location data of the user device 106A. As described in further detail below, this location data may be used to modify the restriction applied to the transaction request, which may allow the transaction request to be validated and/or effectuated despite the original restriction. If the analysis circuitry 208 determines that the transaction request does not include location data, the analysis circuitry 208 may use the communications hardware 206 to provide a request for location data to the user device 106A. Thus, in some embodiments, the communications hardware 206 may receive location data of the user device 106A and/or device signals of devices proximate to the user device 106A in a separate communication rather than in the transaction request.

As shown by operation 506, the apparatus 200 includes means, such as the communications hardware 206, the analysis circuitry 208, or the like, for determining whether the location data corresponds to a trusted location associated with a verified trusted organization. The analysis circuitry 208 may use the location data from the user device 106A, as received in the transaction request or a separate communication, to determine whether the user device 106A, and therefore, the user, is located at a trusted location. If the user is located at a trusted location, either when the transaction request was initially received or shortly thereafter, this may allow the analysis circuitry 208 to modify the restrictions and potentially validate the transaction. Said otherwise, the presence of the user at a trusted location may serve as its own verification factor that may increase confidence in the legitimacy of the transaction request. A user's physical presence at a trusted location reduces the likelihood of fraud, particularly when the trusted location implements its own security protocols (e.g., surveillance, authentication procedures, biometric verification, and/or the like).

In some embodiments, the analysis circuitry 208 may query the verified trusted organization repository 110 using the location data. In some embodiments, the analysis circuitry 208 may use the communications hardware 206 to query the verified trusted organization repository 110. As described in FIG. 4, the verified trusted organization repository 110 may store records of each verified trusted organization. A record for a verified trusted organization may include one or more trusted locations that have been verified as being associated with the verified trusted organization. Thus, trusted locations are locations known to be affiliated with a verified trusted organization and therefore provide an enhanced level of security and/or trust.

In some embodiments, the analysis circuitry 208 may query the verified trusted organization repository 110 for an exact match between the location data provided by the user device 106A and a stored trusted location. For example, the analysis circuitry 208 may query the verified trusted organization repository 110 for the exact GPS coordinates included in the transaction request.

In some embodiments, if an exact match is not found, the analysis circuitry 208 may identify a trusted location that is within a predefined radius of the location data. For example, the analysis circuitry 208 may query the verified trusted organization repository 110 for the GPS coordinates of a trusted location within 100 meters of the GPS coordinates included in the transaction request. In some embodiments, the GPS coordinates for a trusted location may correspond to the single latitude/longitude point, which may correspond to the center of a building, an entry point, an exit point, etc. Additionally, the accuracy of the location data provided by the user device 106A may vary. For example, the typical accuracy of GPS data with smartphones is between 3-10 meters. In some embodiments, GPS coordinates for a trusted location may, additionally or alternatively, correspond to an area with multiple GPS coordinates that may form a geofenced boundary. Thus, the predefined radius may allow the analysis circuitry 208 to identify a corresponding trusted location in a flexible manner that is considerate of varying degrees of GPS accuracy and boundaries of the trusted location.

If the analysis circuitry 208 determines the location data corresponds to (e.g., is located at or within) a trusted location associated with a verified trusted organization, the process may proceed to operation 508. Alternatively, if the analysis circuitry 208 determines the location data fails to correspond to a trusted location associated with a verified trusted organization, the process may proceed to operation 514.

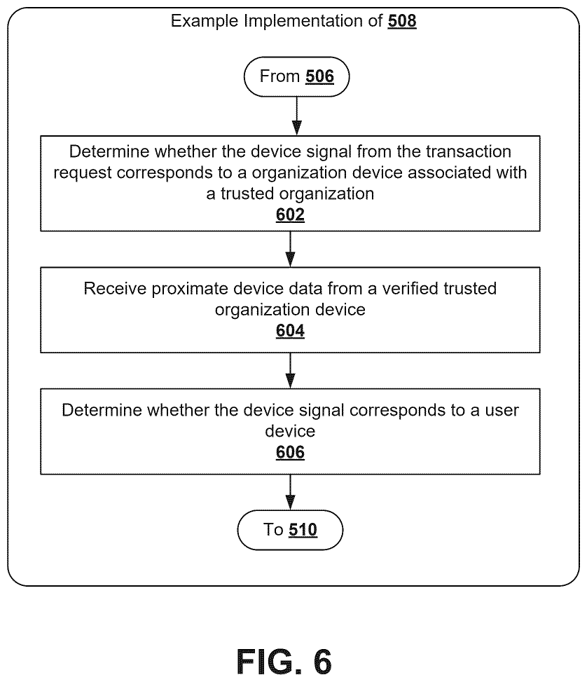

Optionally, as shown by operation 508, the apparatus 200 includes means, such as the communications hardware 206, the analysis circuitry 208, or the like, for evaluating received device signals. In some embodiments, the analysis circuitry 208 may additionally evaluate device signals received by the communications hardware 206. In some embodiments, the device signals may be received from the user device 106A, and these device signals may be included in the transaction request or a separate communication. Additionally or alternatively, the communications hardware 206 may receive a communication from an organization device (e.g., any one of organization devices 108A-108N), and the communication may include device signals. As described in further detail in FIG. 6, the analysis circuitry 208 may be configured to evaluate whether device signals received from the user device 106A correspond to an organization device known to be associated with a verified trusted organization and/or whether device signals received from an organization device correspond to the user device 106A. Received device signals may provide context to the analysis circuitry 208 that allow the analysis circuitry 208 to better evaluate and determine how to modify a restriction. That is, if the analysis circuitry 208 determines that a device signal is indicative of either the user device 106A or an organization device known to be associated with the verified trusted organization, this may provide further proof that the user is at the trusted location.

In some embodiments, operation 508 may be performed in accordance with the operations described by FIG. 6. Turning now to FIG. 6, example operations are shown for evaluating received device signals. Optionally, as shown by operation 602, the apparatus 200 includes means, such as the communications hardware 206, the analysis circuitry 208, or the like, for determining whether the device signal from the transaction request corresponds to an organization device associated with a trusted organization. In some embodiments, the communications hardware 206 may receive a device signal from the user device 106A. For example, the transaction request may include one or more device signals of devices that are proximate to the user device 106A. Alternatively, the communications hardware 206 may receive a separate communication from the user device 106A that includes one or more device signals of devices proximate to the user device 106A.

A device proximate to the user device may refer to a device, such as an organization device (e.g., any one of organization devices 108A-108N) that is within a threshold distance from the user device 106A such that the user device 106A may detect a signal from the device. The threshold distance from the user device 106A may vary depending on the type of device signal. For example, device signals may be a Bluetooth signal, NFC signal, RFID signal, UWB signal, and/or the like. A Bluetooth signal may have a range of up to 100 meters, an NFC signal may have a range of up to 10 centimeters, an RFID signal may have a range of up to 100 meters, and a UWB signal may have a range up to 50 meters. Thus, if the user device 106A detects a signal from a device, this may indicate that the device is within a threshold distance from the user device 106A.

As described above, each device signal may include a device identifier that is indicative of the device providing the signal. The analysis circuitry 208 may use the device identifier from the device signal to determine whether the user device 106A is within a threshold distance from an organization device (e.g., any one of organization devices 108A-108N). The analysis circuitry 208 may query the verified trusted organization repository 110 for the device identifier. In some embodiments, the analysis circuitry 208 may use the communications hardware 206 to perform the query. For example, the analysis circuitry 208 may query the verified trusted organization repository 110 for a device MAC address, NFC tag identifier, unique tag identifier, randomized identifier, and/or the like. The analysis circuitry 208 may query the verified trusted organization repository 110 for an exact match between the device identifier and a stored device identifier of an organization device associated with a verified trusted organization. In some embodiments, the analysis circuitry 208 may restrict, filter, or otherwise limit the query to device identifiers associated with the trusted location, thereby conserving computational resources.

Optionally, as shown by operation 604, the apparatus 200 includes means, such as the communications hardware 206, the analysis circuitry 208, or the like, for receiving proximate device data from an organization device. In some embodiments, the communications hardware 206 may receive proximate device data from an organization device (e.g., any one of organization devices 108A-108N). In some embodiments, an organization device, such as the organization device 108A, may be configured to provide proximate device data to the communications hardware 206 continuously or at periodic intervals (e.g., every 10 minutes). Additionally or alternatively, the organization device 108A may be configured to provide proximate device data in response to interaction with a user device, such as the user device 106A. For example, the communications hardware 206 may receive proximate device data from the organization device 108A in response to a user device performing an NFC tap or other interaction with the organization device 108A.

In some embodiments, the organization device 108A may be configured to detect nearby or proximate signals from other devices in addition to producing device signals. For example, in some embodiments, the organization device 108A may be configured to provide and detect Bluetooth signals. Alternatively, the organization device 108A may be configured solely to detect other device signals.

Proximate device data may include device signals of user devices and/or other devices, such as other nearby organization devices, within a threshold distance of the organization device 108A. Here, the threshold distance is dependent upon the range of the organization device 108A. As described above, a Bluetooth signal may have a range of up to 100 meters, an NFC signal may have a range of up to 10 centimeters, an RFID signal may have a range of up to 100 meters, and a UWB signal may have a range up to 50 meters. Thus, the organization device 108A may detect devices, such as the user device 106A, if the device is within the threshold distance from the organization device 108A.

Optionally, as shown by operation 606, the apparatus 200 includes means, such as the communications hardware 206, the analysis circuitry 208, or the like, for determining whether the device signal corresponds to a user device. As described above, a device signal may include a device identifier that is indicative of the device providing the signal. The analysis circuitry 208 may use the device identifier from the device signal to determine whether the user device 106A is within a threshold distance from the organization device 108A. The analysis circuitry 208 may query the associated user account for the device identifier. In some embodiments, the user account may store a device identifier for each device associated with the user account. For example, if a user device was used to log into the user account, the device information of the user device may be captured and stored in the user account. This may include device identifiers such as an IMEI, device MAC address, unique identifier, IP address, and/or the like. Thus, the analysis circuitry 208 may query the user account for an IMEI, device MAC address, unique identifier, IP address, and/or the like. The analysis circuitry 208 may query the user account for an exact match between the device identifier and a stored device identifier of a user device associated with the user account.

Returning now to FIG. 5, as shown by operation 510, the apparatus 200 includes means, such as the analysis circuitry 208 or the like, for modifying the restriction applied to the transaction request. The analysis circuitry 208 may modify the restriction applied to the transaction request when it determines the location data corresponds (e.g., is located at or within) to a trusted location. Additionally, in some embodiments, the analysis circuitry 208 may modify the restriction based on the evaluation of device signals received from the user device 106A and/or the organization device (e.g., any one of organization devices 108A-108N). The analysis circuitry 208 may modify a restriction by dynamically adjusting, relaxing, or removing the restriction from the user account.

In some embodiments, the analysis circuitry 208 may implement a tiered restriction modification framework when modifying a restriction. In particular, a first tier may allow the analysis circuitry 208 to modify a restriction if the location data corresponds to a trusted location but no device signals were evaluated and/or no proximate corresponding user device and/or organization devices were identified from received device signal data. The first tier may define a first-tier restriction modification rule set that defines how a restriction may be modified by the analysis circuitry 208. In some embodiments, the first-tier restriction modification rule set may define new limits for a transaction. For example, the first tier may define new maximum transaction limits per transaction, new maximum daily transaction limits (or other time frame limit), new limits on a transaction originating from or directed to certain geographic locations, new limits based on a user account age, new limits based on an associated user device trust score, new user-defined limits, and/or the like. The new limit may be greater than the initial limit imposed by the restriction.

In some embodiments, the first-tier restriction modification rule set may further define whether a user account freeze may be removed. The first-tier restriction modification rule set may define whether a user account freeze may be removed based on the cause of the user account freeze. For example, a cause of a user account freeze may be multiple failed login attempts, an unrecognized device login, a geographic mismatch (e.g., use of a virtual private network or proxy during login), unusual spending patterns, account abuse (e.g., excessive chargebacks), pending user verification for user account, fraud investigation hold, a legal freeze, and/or the like. By way of continuing example, the first-tier restriction modification rule set may define that a user account freeze may be removed for causes of multiple failed login attempts, an unrecognized device login, and a geographic mismatch. These user account freezes may be lower-risk freezes that are more easily resolvable. The determination that the location data from the user device 106A is at or within a trusted location may serve as an additional verification factor that may allow these lower-risk freezes to be removed while still maintaining user account security. The analysis circuitry 208 may determine the cause of a user account freeze from the user account, which may provide a code, flag, or other indicator instructive of the cause of the freeze.

In some embodiments, the first-tier restriction modification rule set may further define whether authentication steps may be bypassed for the transaction request. For example, the first-tier restriction modification rule set may define that no additional authentication steps need to be performed for the transaction request.

A second tier may allow the analysis circuitry 208 to modify a restriction if the location data corresponds to a trusted location and at least one proximate, corresponding user device and/or organization device was identified from received device signal data. The second tier may define a second-tier restriction modification rule set that defines how a restriction may be modified by the analysis circuitry 208. In some embodiments, the second-tier restriction modification rule set may define new limits for a transaction. For example, the second tier may define new maximum transaction limits per transaction, new maximum daily transaction limits (or other time frame limit), new limits on a transaction originating from or directed to certain geographic locations, new limits based on a user account age, new limits based on an associated user device trust score, new user-defined limits, and/or the like. The new limit imposed by the second-tier restriction modification rule set may be greater than the initial limit imposed by the restriction and new limits of the first-tier restriction modification rule set. The limits of the second-tier restriction modification rule set may be higher than both the initial limits and the first-tier restriction modification rule set because the detection of a trusted organization device within proximity of the user device 106A and/or the detection of the user device 106A within proximity of a trusted organization device serves as an additional verification element that may increase confidence in the legitimacy of the transaction request.

In some embodiments, the second-tier restriction modification rule set may further define whether a user account freeze may be removed. The second-tier restriction modification rule set may define whether a user account freeze may be removed based on the cause of the user account freeze. For example, the second-tier restriction modification rule set may define that a user account freeze may be removed for causes of multiple failed login attempts, an unrecognized device login, a geographic mismatch, unusual spending patterns, excessive chargebacks, and pending user verification for the user account. The second-tier restriction modification rule set may allow for removal of both lower-risk freezes and moderate-risk freezes. Moderate-risk freezes may correspond to causes that are more serious than low-risk freezes but are still resolvable with verification. The additional verification of the user presence at the trusted location provided by the device signal data may serve as an additional verification factor that may allow both moderate-and low-risk freezes to be removed while still maintaining user account security.

In some embodiments, the second-tier restriction modification rule set may further define whether authentication steps may be bypassed for the transaction request. For example, the second-tier restriction modification rule set may define that no additional authentication steps need to be performed for the transaction request.

The analysis circuitry 208 may modify the restriction using the tiered restriction modification framework. The analysis circuitry 208 may determine whether to use a first-tier restriction modification rule set or a second-tier restriction modification rule set. For example, if the analysis circuitry 208 determines that the location of data corresponds to a trusted location but did not determine any proximate device information, as described in operation 508, the analysis circuitry 208 may use the first-tier restriction modification rule set. As another example, if the analysis circuitry 208 determines that the location of data corresponds to a trusted location and determines the user device 106A was detected by an organization device and/or an organization device was detected by the user device 106A, the analysis circuitry 208 may use the second-tier restriction modification rule set. The analysis circuitry 208 may then update the user account to modify any applied restrictions. In some embodiments, restrictions may only be temporarily modified. For example, a modified restriction may only have an increased transaction limit for a single transaction, for a limited time, or for the duration the user device 106A is determined to be located at the trusted location.

As shown by operation 512, the apparatus 200 includes means, such as the analysis circuitry 208 or the like, for evaluating whether the transaction request is permissible based on the modified restriction. The analysis circuitry 208 may further evaluate whether the transaction request is permissible in view of the modified restrictions associated with the user account. The analysis circuitry 208 may evaluate the transaction type and/or transaction data of the transaction request, such as a transaction amount, a recipient account, a recipient device, a transaction date, a selected payment rail, and/or the like, to determine whether the transaction request is allowed or permissible.

For example, the user device 106A may provide a transaction request for a fund transfer for the transaction amount of $5,000. The analysis circuitry 208 may determine that a restriction applies to the transaction request. Specifically, the analysis circuitry 208 may determine that for fund transfer requests, the maximum limit per transaction is $3,000. The analysis circuitry 208 may further determine that location data provided in the transaction request corresponds to a trusted location associated with verified trusted organization XYZ. The communications hardware 206 may not receive device signal data from the user device 106A or organization devices associated with the trusted location. Thus, the analysis circuitry 208 may determine to modify the restriction using a first-tier restriction modification rule set. The first-tier restriction modification rule set may define a new maximum limit per transaction of $4,000. The analysis circuitry 208 may modify the restriction in the user account and evaluate whether the transaction request is possible based on the modified restriction. Here, the analysis circuitry 208 may determine the transaction request is not permissible because the transaction amount still exceeds the new maximum limit per transaction of the modified restriction.

As another example, the user device 106A may provide a transaction request for a fund transfer for the transaction amount of $5,000, and the analysis circuitry 208 may determine that for fund transfer requests, the maximum limit per transaction is $3,000 as in the previous example. The analysis circuitry 208 may determine that location data provided in the transaction request corresponds to a trusted location associated with verified trusted organization XYZ. The analysis circuitry 208 may further determine that a device signal included in the transaction request corresponds to an organization device that is associated with the trusted location. Thus, the analysis circuitry 208 may determine to modify the restriction using a second-tier restriction modification rule set. The second-tier restriction modification rule set may define a new maximum limit per transaction of $5,000. The analysis circuitry 208 may modify the restriction in the user account and evaluate whether the transaction request is possible based on the modified restriction. Here, the analysis circuitry 208 may determine the transaction request is permissible because the transaction amount does not exceed the new maximum limit per transaction of the modified restriction.

If the analysis circuitry 208 determines the transaction is not permissible, the process may proceed to operation 514. Alternatively, if the analysis circuitry 208 determines the transaction is permissible, the process may proceed to operation 520.

As shown by operation 514, the apparatus 200 includes means, such as the analysis circuitry 208 or the like, for denying the transaction request. If the analysis circuitry 208 determines the location data provided by the user device 106A fails to correspond to a trusted location associated with a verified trusted organization or if the analysis circuitry 208 determines the transaction request is not permissible, the analysis circuitry 208 may deny the transaction request. That is, the requested transaction and/or account operation indicated by the transaction request may not be performed.

Optionally, as shown by operation 516, the apparatus 200 includes means, such as the analysis circuitry 208 or the like, for selecting a nearby trusted location. In some embodiments, if the location data fails to correspond to a trusted location, the analysis circuitry 208 may identify a nearby trusted location for the user. The analysis circuitry 208 may query the verified trusted organization repository 110 using the location data received from the user device 106A as described in operation 506. Here, the analysis circuitry 208 may identify one or more trusted locations that are closest from the user device's current location. In some embodiments, the analysis circuitry 208 may determine whether a distance between the user device's current location as indicated by the location data is within a threshold distance (e.g., 50 miles) from a trusted location. The analysis circuitry 208 may identify one or more trusted locations within the threshold distance. In some embodiments, the analysis circuitry 208 may further determine a distance between the user device and a trusted location for each identified trusted location. In some embodiments, the analysis circuitry 208 may select the closest n identified trusted locations, where n is a predefined number of selectable trusted locations.

Optionally, as shown by operation 518, the apparatus 200 includes means, such as the communications hardware 206, the analysis circuitry 208, or the like, for providing a denial notification. The analysis circuitry 208 may generate a denial notification to inform the user that the transaction request has been denied and cannot be completed. In some embodiments, the denial notification may indicate why the transaction request was denied. For example, the denial notification may indicate that the transaction amount of $5,000 violates a maximum transaction limit per transaction. This allows the user to understand why the transaction request was denied.

In some embodiments, the denial request may further include selected nearby trusted locations. The denial message may further indicate that if the user visits a trusted location, this may allow the transaction request to be completed. In some embodiments, the denial message may indicate the nearest verified trusted organization to the user device 106A. Thus, the user may be made aware of a potential avenue that would allow the transaction request to be completed.

The analysis circuitry 208 may provide the denial notification to the communications hardware 206, which in turn may provide it to the user device 106A. The denial notification may be provided to the user device 106A as a short message service (SMS) text, email, push notification, in-app on-screen notification if there is an active mobile application session with the user device 106A, and/or the like.

Alternatively, as shown by operation 520, the apparatus 200 includes means, such as the analysis circuitry 208 or the like, for validating the transaction request. If the analysis circuitry 208 determines the transaction request is permissible, the analysis circuitry 208 may validate and/or approve the transaction request. In some embodiments, once validated, the analysis circuitry 208 may perform or effectuate an operation or transaction requested in the transaction request. For example, the analysis circuitry 208 may transfer funds of the transaction amount from the user account to a recipient account using the selected payment rail. As another example, the analysis circuitry 208 may instruct an entity device (e.g., any one of entity devices 112A-112N, which may be an automated teller machine) to provide the transaction amount in cash. The analysis circuitry 208 may further validate a requested operation for the user account, such as allowing updates to user information, user device information, beneficiaries, authorized users, and/or the like.

As shown by operation 522, the apparatus 200 includes means, such as the communications hardware 206, the analysis circuitry 208, or the like, for providing a transaction success notification. The analysis circuitry 208 may generate a transaction success notification upon successful validation and/or performance of the transaction request. The transaction success notification may inform the user that the transaction request has been validated and/or performed. The analysis circuitry 208 may provide the transaction success notification to the communications hardware 206, which in turn may provide it to the user device 106A. The transaction success notification may be provided to the user device 106A as an SMS text, email, push notification, in-app on-screen notification if there is an active mobile application session with the user device 106A, and/or the like.

Turning next to FIG. 7, example operations are shown for processing a transaction request that is associated with a product token. As shown by operation 702, the apparatus 200 includes means, such as the communications hardware 206, the analysis circuitry 208, or the like, for receiving a transaction generation request from an organization device. In some embodiments, prior to receiving a transaction request from a user device, the communications hardware 206 may receive a transaction generation request from an organization device (e.g., any one of organization devices 108A-108N). In some embodiments, an organization device, such as the organization device 108A, may initiate a transaction with a user device, such as the user device 106A. Additionally, the transaction generation request may cause a product token to be generated and used for the transaction, thereby ensuring that the items or products involved in the transaction are uniquely identifiable and validated prior to any transaction validation.

In some embodiments, the transaction generation request may include a unique product identifier. A product identifier may uniquely reference a product that a user intends to purchase. In some embodiments, the product identifier is a vehicle identification number, a stock keeping unit, a serial number, a cryptographic hash, and/or any other identifier that identifies a product.

In some embodiments, the transaction generation request may include user information for the user who intends to purchase the product. For example, user information may include a name, email address, phone number, residential address, and/or the like. The transaction generation request may include an indication of the organization device 108A, such as a device identifier. In some embodiments, the transaction generation request includes transaction data, such as a transaction amount.

In some embodiments, the transaction generation request may include candidate device credentials and/or candidate security tokens associated with the organization device 108A and/or the verified trusted organization. In some embodiments, the analysis circuitry 208 may be configured to compare received candidate device credentials and/or candidate security tokens to stored device credentials and/or stored security tokens associated with the organization device 108A and/or the verified trusted organization. If the analysis circuitry 208 determines the candidate device credentials and/or candidate security tokens match the stored device credentials and/or stored security tokens (e.g., are an exact match), the analysis circuitry 208 may allow subsequent operations described in FIG. 7 to proceed. Otherwise, the analysis circuitry 208 may deny the transaction generation request and use the communications hardware 206 to provide a denial notification to the organization device 108A.

As shown by operation 704, the apparatus 200 includes means, such as the authentication circuitry 210 or the like, for generating a product token. The authentication circuitry 210 may receive the product identifier included in the transaction generation request from the communications hardware 206. The authentication circuitry 210 may then be configured to generate a product token. The product token may be used to establish a secure transaction reference that uniquely links a transaction request to a specific product. In some embodiments, the authentication circuitry 210 may generate the product token based on the received product identifier. In some embodiments, the authentication circuitry 210 may use a hash function to generate the product identifier. For example, the authentication circuitry 210 may use a hash function, such as a secure hash algorithm or a hash-based message authentication code, to transform the product identifier into a product token.

In some embodiments, the authentication circuitry 210 may generate the product token based on the received product token and using a nonce. For example, the authentication circuitry 210 may concatenate the product token and the nonce into an input string. The authentication circuitry 210 may then apply a hash function to the input string and generate the product token.

As shown by operation 706, the apparatus 200 includes means, such as the memory 204, the authentication circuitry 210, or the like, for storing the product token. Once the authentication circuitry 210 has generated the product token, it may store the product token in an associated memory, such as the memory 204. This may allow the authentication circuitry 210 to subsequently verify a received candidate product token.

As shown by operation 708, the apparatus 200 includes means, such as the communications hardware 206, the authentication circuitry 210, or the like, for providing an initial transaction request. Once the authentication circuitry 210 has generated the product token, it may provide an initial transaction request using the communications hardware 206.

In some embodiments, the communications hardware 206 may provide the initial transaction request to the organization device 108A, which in turn may provide it to the user device 106A. In particular, the organization device 108A may provide the initial transaction request to the user device 106A using NFC, Bluetooth, Wi-Fi, and/or the like. In some embodiments, this approach may be beneficial, as it allows the organization device 108A to filter out any fraudulent transaction requests before they reach the user device 106A. This approach further mitigates the risk of man-in-the-middle attacks because the organization device 108A may use encrypted transmission methods (e.g., NFC, Bluetooth, or a local network) to securely relay the initial transaction request to the user device 106A.

Alternatively, in some embodiments, the communications hardware 206 may be configured to provide the initial transaction directly to the user device 106A. In some embodiments, the transaction generation request may indicate user information that is indicative of the identity of the user device 106A (e.g., an associated phone number). In some embodiments, the authentication circuitry 210 may use this information to identify the user device 106A from the user account. In some embodiments, the initial transaction request may be provided to the user device 106A as an SMS text, email, push notification, in-app on-screen notification if there is an active mobile application session with the user device 106A, and/or the like. Advantageously, direct provision of the initial transaction request removes the intermediate operation of first sending the initial transaction request to the organization device 108A. This reduces the overall network latency.

In some embodiments, the authentication circuitry 210 may populate the initial transaction request based on the information included in the transaction generation request. For example, in some embodiments, the authentication circuitry 210 may include the transaction amount for the transaction, a recipient account (e.g., as determined from the user information), and/or the like.

In some embodiments, the authentication circuitry 210 may query the verified trusted organization repository 110 to identify a record for a verified trusted organization that corresponds to the organization device 108A. For example, the authentication circuitry 210 may query the verified trusted organization repository 110 using an organization device identifier and may identify the record that includes a match for the organization device identifier. The authentication circuitry 210 may identify the one or more acceptable payment rails indicated in the record. In some embodiments, the authentication circuitry 210 may select a default payment rail for the initial transaction request and format the initial transaction request accordingly. The authentication circuitry 210 may further provide an indication of other acceptable payment rails in the initial transaction request. This may allow the user to provide a transaction request over a payment rail acceptable to both the user and the verified trusted organization.

In some embodiments, if the user prefers to use a different payment rail than the default payment rail, the communications hardware 206 may receive an initial transaction update request from the user device 106A. The initial transaction update request may include the user's preferred payment rail, which may also be an acceptable payment rail for the verified trusted organization. The authentication circuitry 210 may update and/or reformat the initial transaction request to accommodate the user's preference.

In some embodiments, the initial transaction request may include the nonce value used to generate the product token. This may enable the user device 106A to generate its own candidate product token using the nonce and a captured product identifier.

As shown by operation 710, the apparatus 200 includes means, such as the communications hardware 206 or the like, for receiving a transaction request from the user device. The communications hardware 206 may receive the transaction request from the user device 106A. The transaction request may be received from the user device 106A in a substantially similar manner as described in operation 502 of FIG. 5.

In some embodiments, the transaction request may additionally include a candidate product identifier. The candidate product identifier may have been captured by the user device 106A, as described in further detail in FIG. 9.

In some embodiments, the transaction request may additionally include a candidate product token. In some embodiments, the user device 106A may be configured to capture a candidate product identifier and use the nonce provided in the initial transaction request to generate a candidate product token.

As shown by operation 712, the apparatus 200 includes means, such as the memory 204, the analysis circuitry 208, the authentication circuitry 210, or the like, for determining whether the candidate product token corresponds to the stored product token. The communications hardware 206 may provide the transaction request to the analysis circuitry 208 for processing. In some embodiments, the analysis circuitry 208 may detect the inclusion of a candidate product token and/or a candidate product identifier in the transaction request and may provide this information to the authentication circuitry 210. The authentication circuitry 210 may be configured to compare the received candidate product token and/or candidate product identifier to the stored product token.

In some embodiments, the authentication circuitry 210 may retrieve the stored product token from memory (e.g., the memory 204) and directly compare the candidate product token to the stored product token. If the candidate product token matches the stored product token, the authentication circuitry 210 may determine the candidate product token corresponds to the stored product token. Otherwise, the authentication circuitry 210 may determine the candidate product token does not correspond to the stored product token.

In some embodiments, the authentication circuitry 210 may retrieve the stored product token from memory (e.g., the memory 204). The authentication circuitry 210 may extract the candidate product identifier, and optionally, the nonce if included, from the transaction request. If not included in the transaction request, the authentication circuitry 210 may retrieve the nonce from memory (e.g., the memory 204). The authentication circuitry 210 may then generate the candidate product token using the extracted candidate product identifier and nonce. In particular, the authentication circuitry 210 may use the same hash function to generate the candidate product token from the candidate product identifier and nonce. The authentication circuitry 210 may then compare the candidate product token to the stored product token. If the candidate product token matches the stored product token, the authentication circuitry 210 may determine the candidate product token corresponds to the stored product token. Otherwise, the authentication circuitry 210 may determine the candidate product token does not correspond to the stored product token.

If the candidate product token is determined to correspond to the stored product token (e.g., matches the stored product token), the process may proceed to operation 504 of FIG. 5, and the operations described in FIG. 5 may be performed for the corresponding transaction request.

If the candidate product token fails to correspond to the stored product token (e.g., does not match the stored product token), the process may proceed to operation 514 of FIG. 5, and the transaction request may be denied.

### Example Operations Performed by an Organization Device

Turning to FIG. 8, example flowcharts are illustrated that contain example operations implemented by example embodiments described herein. The operations illustrated in FIG. 8 may, for example, be performed by any one of organization devices 108A-108N shown in FIG. 1, which may in turn be embodied by an apparatus 300, which is shown and described in connection with FIG. 3. To perform the operations described below, the apparatus 300 may utilize one or more of the processor 302, the memory 304, the communications hardware 306, the identifier generation circuitry 308, the token generation circuitry 310, the location circuitry 312, and/or any combination thereof. It will be understood that user interaction with the organization device may occur directly via the communications hardware 306 or may instead be facilitated by a separate user device (e.g., any one of user devices 106A-106N), a separate entity device (e.g., any one of entity devices 112A-112N), and/or the transaction validation system 102, as shown in FIG. 1, and it may have similar or equivalent physical componentry facilitating such user interaction.

Continuing with FIG. 8, example operations are shown for providing a transaction generation request. Optionally, as shown by operation 802, the apparatus 300 includes means, such as the identifier generation circuitry 308 or the like, for generating a product identifier for a product. In some embodiments, the identifier generation circuitry 308 may generate a product identifier for a product. In some embodiments, the identifier generation circuitry 308 may need to generate a unique product identifier for the product that a user intends to buy. In some embodiments, the product identifier is a vehicle identification number, a stock keeping unit, a serial number, a cryptographic hash, and/or any other identifier that identifies a product. In some embodiments, the identifier generation circuitry 308 may use a pseudorandom number generation function to generate the product identifier.

In some embodiments, the product the user intends to purchase may be unique and specific to the individual product. For example, the user may intend to purchase a specific vehicle from a verified trusted organization. Here, the unique product identifier may identify and/or represent the exact vehicle to be purchased by the user. In some embodiments, the user may wish to purchase a fungible product that is interchangeable with other products of the same kind. For example, the user may wish to purchase XYZ 500 milliliter brand bottled water. The unique product identifier may therefore represent any 500 milliliter bottled water of brand XYZ.

In some embodiments, the identifier generation circuitry 308 may further be configured to generate a visual representation of the product identifier. For example, the identifier generation circuitry 308 may be configured to generate the product identifier as a barcode, Quick Response (QR) code, and/or the like. The visual representation of the product identifier may encode the product identifier. This may allow a user device (e.g., any one of user devices 106A-106N) to capture the product identifier for use in a transaction request.

In some embodiments, the visual representation of the product identifier may be displayed with the particular product. For example, a printout of the QR code may be placed inside a vehicle that a user intends to purchase. This may allow the user to use a user device (e.g., any one of user devices 106A-106N) to scan the QR code, capture the product identifier, and use the product identifier within a transaction request.

As shown by operation 804, the apparatus 300 includes means, such as the processor 302, the communications hardware 306, or the like, for providing a transaction generation request. In some embodiments, the communications hardware 306 may provide a transaction generation request to the transaction validation system 102. In some embodiments, the communications hardware 306 may provide the transaction generation request in response to receiving user input from an authorized user. The user input may include user information, the transaction amount, a product identifier corresponding to the product for the transaction, and/or the like. In some embodiments, the processor 302 may be configured to generate the transaction generation request using the user input. Thus, the transaction generation request may include user information and the product identifier. In some embodiments, the processor 302 may further include device credentials and/or security tokens needed for authorization by the transaction validation system 102.

Optionally, as shown by operation 806, the apparatus 300 includes means, such as the communications hardware 306 or the like, for receiving an initial transaction request. In some embodiments, the communications hardware 306 may receive the initial transaction request from the transaction validation system 102.

Optionally, as shown by operation 808, the apparatus 300 includes means, such as the communications hardware 306 or the like, for providing the initial transaction request to a user device. If the communications hardware 306 receives the initial transaction request from the transaction validation system 102, the communications hardware 306 may provide the initial transaction request to the user device with which apparatus 300 is performing a transaction with, such as the user device 106A. In some embodiments, the communications hardware 306 may use NFC, Bluetooth, or a local network to securely relay the initial transaction request to the user device 106A. In some embodiments, the communications hardware 306 may be configured to provide the initial transaction request with the user device 106A in response to an interaction with the user device 106A, such as an NFC tap.

Optionally, as shown by operation 810, the apparatus 300 includes means, such as the communications hardware 306 or the like, for providing proximate device data. In some embodiments, the communications hardware 306 may be configured to detect device signals within a predefined range. In some embodiments, the communications hardware 306 may be configured to provide proximate device data that includes detected device signals to the transaction validation system 102. The communications hardware 306 may be configured to provide proximate device data to the transaction validation system 102 continuously or at periodic intervals (e.g., every 10 minutes). Additionally or alternatively, the communications hardware 306 may be configured to provide proximate device data in response to an interaction with a user device, such as the user device 106A. For example, the communications hardware 306 may provide proximate device data to the transaction validation system 102 in response to the user device 106A performing an NFC tap or other interaction with the apparatus 300.

### Example Operations Performed by a User Device

Turning to FIG. 9, example flowcharts are illustrated that contain example operations implemented by example embodiments described herein. The operations illustrated in FIG. 9 may, for example, be performed by any one of user devices 106A-106N shown in FIG. 1, which may in turn be embodied by an apparatus 300, which is shown and described in connection with FIG. 3. To perform the operations described below, the apparatus 300 may utilize one or more of the processor 302, the memory 304, the communications hardware 306, the identifier generation circuitry 308, the token generation circuitry 310, the location circuitry 312, and/or any combination thereof. It will be understood that user interaction with the organization device may occur directly via the communications hardware 306 or may instead be facilitated by a separate organization device (e.g., any one of organization devices 108A-108N), a separate entity device (e.g., any one of entity devices 112A-112N), and/or the transaction validation system 102, as shown in FIG. 1, and it may have similar or equivalent physical componentry facilitating such user interaction.

Continuing with FIG. 9, example operations are shown for providing a transaction request. Optionally, as shown by operation 902, the apparatus 300 includes means, such as the communications hardware 306 or the like, for receiving an initial transaction request. In some embodiments, the communications hardware 306 may receive an initial transaction request directly from the transaction validation system 102. Alternatively, the communications hardware 306 may receive an initial transaction request from an organization device (e.g., any one of organization devices 108A-108N). In some embodiments, the communications hardware 306 may need to interact with an organization device, such as the organization device 108A, to receive the initial transaction request. For example, the communications hardware 306 may perform an NFC tap with the organization device 108A.

Optionally, as shown by operation 904, the apparatus 300 includes means, such as the processor 302, the communications hardware 306, or the like, for capturing a product identifier. In some embodiments, the processor 302 may capture a product identifier. For example, the communications hardware 306 may receive user input instructive to open a camera software application and capture a product identifier from a visual representation of the product identifier. The processor 302 may use the camera to scan the visual representation of the product identifier (e.g., a barcode, QR code, or the like) in view of the camera. The processor 302 may decode the product identifier encoded within the visual representation of the product identifier.

Optionally, as shown by operation 906, the apparatus 300 includes means, such as the token generation circuitry 310 or the like, for generating a product token. In some embodiments, the token generation circuitry 310 may use the captured product identifier to generate a product token. If the initial transaction request included a nonce, the token generation circuitry 310 may generate a product token using the captured product identifier and nonce. In some embodiments, the initial transaction request may further be indicative of the hash function the transaction validation system 102 used to generate a product token. The token generation circuitry 310 may use the same hash function with the captured product identifier and nonce to generate the product token.

Optionally, as shown by operation 908, the apparatus 300 includes means, such as the communications hardware 306 or the like, for capturing device signal data. In some embodiments, the communications hardware 306 may be configured to monitor and detect device signals from nearby devices, such as a nearby organization device (e.g., any one of organization devices 108A-108N). The communications hardware 306 may be configured to provide detected device signal data captured over a predefined time window (e.g., within the past 15 minutes) to the transaction validation system 102. In some embodiments, the communications hardware 306 may be configured to provide captured device signal data to the transaction validation system 102 in a transaction request or in a separate communication.

As shown by operation 910, the apparatus 300 includes means, such as the processor 302, the communications hardware 306, or the like, for determining location data. In some embodiments, the communications hardware 306 may receive GPS signals and may determine its location data based on those GPS signals. For example, the communications hardware 306 may receive GPS signals from satellites and the processor 302 may use signal time delays to determine GPS coordinates indicative of the location of the apparatus 300. In some embodiments, the communications hardware 306 may capture Wi-Fi signals, cell tower signals, and/or the like. In some embodiments, the apparatus 300 may use a Wi-Fi positioning system, cell tower triangulation techniques, and/or the like to determine the location data.

As shown by operation 912, the apparatus 300 includes means, such as the processor 302, the communications hardware 306, or the like, for providing a transaction request. The processor 302 may be configured to generate a transaction request for a user account. In some embodiments, the communications hardware 306 may receive user input indicative of a transaction type. The communications hardware 306 may further receive user input indicative of transaction data, such as a transaction amount, a recipient account, a recipient device, a transaction date, a selected payment rail, and/or the like. The processor 302 may cause the communications hardware 306 to provide the transaction request to the transaction validation system 102.

In some embodiments, the processor 302 may generate the transaction request within a mobile application associated with the transaction validation system 102. This may require the user to be authenticated by the transaction validation system 102 and provide the transaction request during an active session.

The processor 302 may include the location data determined in operation 910 in the transaction request. Additionally, the processor 302 may include device signal data in the transaction request.

If a product identifier was captured and/or a product token was generated, as described in operations 904-906, the processor 302 may include the product identifier, product token, and/or nonce in the transaction request. In some embodiments, the apparatus 300 may only capture a product identifier, and thus, the processor 302 may include the product identifier, and optionally, the nonce if received in the initial transaction request, but not the product identifier in the transaction request. Alternatively, if the token generation circuitry 310 generated a product token, the processor 302 may include the product token, and optionally, the product identifier and nonce, in the transaction request.

In some embodiments, if the communications hardware 306 received an initial transaction request, the user may interact with the initial transaction request to automatically generate a transaction request. As described above, in some embodiments, the initial transaction request may be populated by the transaction validation system 102. The processor 302 may use this prepopulated data to generate the transaction request. In some embodiments, the initial transaction request may be formatted in accordance with a payment rail selected by default by the transaction validation system 102. The communications hardware 306 may allow a user to select a different, approved payment rail for the transaction request. If the user selects a different payment rail, the communications hardware 306 may provide an initial transaction update request that includes the user's preferred payment rail. The communications hardware 306 may receive an updated initial transaction request directly from the transaction validation system 102 or from the organization device 108A. The updated initial transaction request may be reformatted based on the user's selected payment rail.

As shown by operation 914, the apparatus 300 includes means, such as the communications hardware 306 or the like, for receiving a notification. After provision of the transaction request, the communications hardware 306 may receive a notification from the transaction validation system 102. In some embodiments, the notification is a transaction success notification. The transaction success notification may inform the user that the transaction request has been validated and/or performed by the transaction validation system 102.

Alternatively, the notification is a denial notification. A denial notification may inform the user that the transaction request has been denied and cannot be completed. In some embodiments, the denial notification may indicate why the transaction request was denied. This allows the user to understand why the transaction request was denied. The user may thus correct or remedy issues that caused the denial and may submit a new transaction request if desired. This may cause the process to restart.

In some embodiments, the denial request may further include selected nearby trusted locations. The denial message may further indicate that if the user visits a trusted location, this may allow the transaction request to be completed. Thus, the user may be made aware of a potential avenue that would allow the transaction request to be completed.

FIGS. 4-9 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special-purpose, hardware-based computing devices that perform the specified functions or combinations of special-purpose hardware and software instructions.

### Conclusion

As described above, example embodiments provide methods and apparatuses that leverage trusted locations and contextual authentication to provide more efficient and secure transaction request processing. Unlike conventional systems that rely on rigid transaction limits, example embodiments dynamically adjust transaction security (e.g., restrictions) based on real-time user device location data and device signals. By maintaining a verified trusted organization repository, example embodiments enhance transaction legitimacy verification and reduce the likelihood of fraudulent activity. Furthermore, the use of a tiered restriction modification framework offers flexibility and efficiency by allowing transaction requests from verified trusted locations to be processed with minimal user friction while also allowing for varying degrees of restriction modification.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for secure transaction validation, the method comprising:
receiving, by communications hardware, a transaction request from a user device, wherein (a) the transaction request is associated with a user account, and (b) the transaction request comprises location data of the user device;
determining, by analysis circuitry, that a restriction applies to the transaction request for the user account;
determining, by the analysis circuitry and using a verified trusted organization repository, whether the location data corresponds to a trusted location associated with a verified trusted organization;
in response to determining that the location data corresponds to the trusted location, modifying, by the analysis circuitry, the restriction applied to the transaction request;
evaluating, by the analysis circuitry, whether the transaction request is permissible based on the modified restriction; and
in response to determining that the transaction request is permissible, validating, by the analysis circuitry, the transaction request for the user account.

2. The method of claim 1, further comprising:
in response to determining that the location data does not correspond to a trusted location, denying, by the analysis circuitry, the transaction request;
selecting, by the analysis circuitry, a trusted location based on a proximity of the location data to the trusted location; and
providing, by the communications hardware, a denial notification to the user device, wherein the denial notification comprises an indication that the transaction request was denied and information regarding a nearest verified trusted organization.

3. The method of claim 1, wherein the transaction request further comprises a device signal corresponding to a device proximate to the user device,
wherein the method further comprises:
determining, by the analysis circuitry, whether the device signal corresponds to an organization device associated with the verified trusted organization; and
modifying, by the analysis circuitry, the restriction applied to the transaction request based on whether the device signal corresponds to the organization device.

4. The method of claim 1, further comprising:
receiving, by the communications hardware, proximate device data from an organization device, wherein the proximate device data comprises a device signal corresponding to a user device proximate to the organization device;
determining, by the analysis circuitry, whether the device signal corresponds to the user device; and
modifying, by the analysis circuitry, the restriction applied to the transaction request based on whether the device signal corresponds to the user device.

5. The method of claim 1, further comprising:
receiving, by the communications hardware, an application request for an organization to register as a verified trusted organization, wherein the application request comprises at least one organization location;
receiving, by the communications hardware, approval of the application request from an authorized user; and
updating, by the analysis circuitry, the verified trusted organization repository to include the organization as a verified trusted organization and the at least one organization location as a trusted location.

6. The method of claim 1, wherein the restriction applied to the transaction request is based on one or more of user account settings, a transaction type, and a transaction amount.

7. The method of claim 1, wherein the method further comprises:
evaluating, by authentication circuitry, whether a candidate product token corresponds to a stored product token, wherein the transaction request is validated in response to determining that the transaction request is permissible and that the candidate product token corresponds to the stored product token.

8. The method of claim 7, further comprising:
prior to receiving the transaction request, receiving, by the communications hardware, a transaction generation request from an organization device, wherein the transaction generation request comprises a product identifier;
generating, by the authentication circuitry, a product token based on the product identifier; and
storing, by the authentication circuitry, the product token.

9. The method of claim 8, wherein the product token is generated based on a nonce,
wherein the method further comprises:
generating, by the authentication circuitry, an initial transaction request comprising the nonce; and
providing, by the communications hardware, the initial transaction request to at least one of the organization device and the user device, wherein the transaction request comprises the candidate product token.

10. The method of claim 8, wherein the product token is generated based on a nonce value,
wherein the method further comprises:
extracting, by the authentication circuitry, a candidate product identifier from the transaction request; and
generating, by the authentication circuitry, the candidate product token using the extracted candidate product identifier and the nonce.

11. An apparatus for secure transaction validation, the apparatus comprising:
communications hardware configured to receive a transaction request from a user device, wherein (a) the transaction request is associated with a user account, and (b) the transaction request comprises location data of the user device; and
analysis circuitry configured to:
determine that a restriction applies to the transaction request for the user account,
determine, using a verified trusted organization repository, whether the location data corresponds to a trusted location associated with a verified trusted organization,
in response to determining that the location data corresponds to the trusted location, modify the restriction applied to the transaction request,
evaluate whether the transaction request is permissible based on the modified restriction, and
in response to determining that the transaction request is permissible, validate the transaction request for the user account.

12. The apparatus of claim 11, wherein the analysis circuitry is further configured to:
in response to determining that the location data does not correspond to a trusted location, deny the transaction request, and
select a trusted location based on a proximity of the location data to the trusted location,
wherein the communications hardware is further configured to provide a denial notification to the user device, wherein the denial notification comprises an indication that the transaction request was denied and information regarding a nearest verified trusted organization.

13. The apparatus of claim 11, wherein the transaction request further comprises a device signal corresponding to a device proximate to the user device,
wherein the analysis circuitry is further configured to:
determine whether the device signal corresponds to an organization device associated with the verified trusted organization, and
modify the restriction applied to the transaction request based on whether the device signal corresponds to the organization device.

14. The apparatus of claim 11, wherein the communications hardware is further configured to receive proximate device data from an organization device, wherein the proximate device data comprises a device signal corresponding to a user device proximate to the organization device,
wherein the analysis circuitry is further configured to:
determine whether the device signal corresponds to the user device, and
modify the restriction applied to the transaction request based on whether the device signal corresponds to the user device.

15. The apparatus of claim 11, wherein the communications hardware is further configured to:
receive an application request for an organization to register as a verified trusted organization, wherein the application request comprises at least one organization location, and
receive approval of the application request from an authorized user,
wherein the analysis circuitry is further configured to update the verified trusted organization repository to include the organization as a verified trusted organization and the at least one organization location as a trusted location.

16. The apparatus of claim 11, wherein the restriction applied to the transaction request is based on one or more of user account settings, a transaction type, and a transaction amount.

17. The apparatus of claim 11, further comprising authentication circuitry configured to evaluate whether a candidate product token corresponds to a stored product token, wherein the transaction request is validated in response to determining that the transaction request is permissible and that the candidate product token corresponds to the stored product token.

18. The apparatus of claim 17, wherein the communications hardware is further configured to, prior to receiving the transaction request, receive a transaction generation request from an organization device, wherein the transaction generation request comprises a product identifier,
wherein the authentication circuitry is further configured to:
generate a product token based on the product identifier, and
store the product token.

19. The apparatus of claim 18, wherein the product token is generated based on a nonce,
wherein authentication circuitry is further configured to generate an initial transaction request comprising the nonce,
wherein the communications hardware is further configured to provide the initial transaction request to at least one of the organization device and the user device, wherein the transaction request comprises the candidate product token.

20. A computer program product for secure transaction validation, the computer program product comprising at least one non-transitory computer-readable storage medium storing software instructions that, when executed, cause an apparatus to:
receive a transaction request from a user device, wherein (a) the transaction request is associated with a user account, and (b) the transaction request comprises location data of the user device;
determine that a restriction applies to the transaction request for the user account;
determine, using a verified trusted organization repository, whether the location data corresponds to a trusted location associated with a verified trusted organization;
in response to determining that the location data corresponds to the trusted location, modify the restriction applied to the transaction request;
evaluate whether the transaction request is permissible based on the modified restriction; and
in response to determining that the transaction request is permissible, validating the transaction request for the user account.
